(19) United States
(12) Patent Application Publication
(10) Pub. No.: US 2012/0285095 A1
(43) Pub. Date: Nov. 15, 2012

(54) DOOR ASSEMBLY FOR AN ELECTRONIC EQUIPMENT RACK

(75) Inventors: Dale Bart Clark, JR., Sparks, NV (US); Robert James Trimble, Canyon Lake, CA (US)

(73) Assignee: COOPER TECHNOLOGIES COMPANY, Houston, TX (US)

(21) Appl. No.: 13/103,696

(22) Filed: May 9, 2011

(51) Int. Cl. E06B 3/70; E06B 3/36; E05B 65/06

(52) U.S. Cl. 49/366; 49/394

(57) ABSTRACT

A door assembly for an equipment rack. A unitary frame includes an upper horizontal member, a left-hand vertical member, and a right-hand vertical member. A left-hand door is pivotally mounted on the left-hand vertical member for movement between an open position, in which equipment is accessible through a left-hand portion of the frame, and a closed position, in which access to equipment through the left-hand portion is blocked by the left-hand door. A right-hand door is pivotally mounted on the right-hand vertical member for movement between an open position, in which equipment is accessible through a right-hand portion of the frame, and a closed position, in which access to equipment through the right-hand portion is blocked by the right-hand door. A locking mechanism locks the left-hand door and the right-hand door in their respective closed positions, thereby blocking access to the equipment through the frame.

### BACKGROUND

The present invention generally relates to electronic equipment racks, and more particularly to a door assembly for an electronic equipment rack.

Equipment racks are widely used for holding electronic equipment, such as telecommunications equipment and computer equipment. Typically, the racks are open three dimensional frames that hold equipment in a vertical column. Because the frames are open, they permit access to cables connecting the equipment and permit heat generated by the equipment to dissipate. Conventionally, the racks are located in rooms having high capacity cooling systems to reduce heat in the rooms. Further, the rooms are often locked to prevent unauthorized access. Malevolent persons could easily damage equipment or systems if they were able to gain access. Moreover, these equipment racks often house sensitive equipment (e.g., telephone switches and computers) that is crucial to a business operation, so security of the equipment is a concern. Thus, there is a need for a door assembly for preventing access to the equipment held in the equipment racks in the event malevolent persons gain access to the equipment rooms. Further, there is a need for a door assembly that can retrofit existing equipment racks. Doors can block visual inspection of the status of equipment held in the racks. Thus, there is a need for a door assembly that permits visual inspection of the equipment in the racks without opening the corresponding doors. And lastly, there is a need for a door assembly that permits heat transfer around the equipment held in the racks to prevent potentially damaging heat buildup around the equipment.

### SUMMARY

The present invention relates to a door assembly for an equipment rack. The assembly comprises a unitary frame including an upper horizontal member extending between a left end and right end opposite the left end. A left-hand vertical member extends downward from an upper end connected to the left end of the upper horizontal member to a lower end opposite the upper end. A right-hand vertical member extends downward from an upper end connected to the right end of the upper horizontal member to a lower end opposite the upper end. A left-hand door is pivotally mounted on the left-hand vertical member for movement between an open position, in which equipment in the equipment rack is accessible through a left-hand portion of the frame, and a closed position, in which access to the equipment through the left-hand portion of the frame is blocked by the left-hand door. A right-hand door is pivotally mounted on the right-hand vertical member for movement between an open position, in which equipment in the equipment rack is accessible through a right-hand portion of the frame, and a closed position, in which access to the equipment through the right-hand portion of the frame is blocked by the right-hand door. A locking mechanism is mounted on at least one of the frame, the left-hand door, and the right-hand door for locking the left-hand door and right-hand door in their respective closed positions, thereby blocking access to the equipment through the frame.

In another aspect, a door assembly for an equipment rack comprises an upper horizontal member extending between a left end and a right end. The upper horizontal member has an opening for receiving a fastener to fasten the frame to the equipment rack. A lower horizontal member extends between a left end and a right end and has an opening for receiving a fastener to fasten the frame to the equipment rack. A left-hand vertical member joins the left end of the upper horizontal member to left end of the lower horizontal member. At least a portion of a rearward surface of the left-hand vertical member is offset from those of the upper horizontal member and the lower horizontal member so the left-hand vertical member is spaced from the equipment rack when the door assembly is fastened to the equipment rack. The left-hand vertical member partially defines an opening between the left-hand vertical member and the equipment rack. A right-hand vertical member joins the right end of the upper horizontal member to right end of the lower horizontal member. At least a portion of a rearward surface of the right-hand vertical member is offset from those of the upper horizontal member and the lower horizontal member so the right-hand vertical member is spaced from the equipment rack when the door assembly is fastened to the equipment rack. The right-hand vertical member partially defines an opening between the right-hand vertical member and the equipment rack. A door is pivotally mounted on one of the left-hand vertical member and the right-hand vertical member for movement between an open position, in which equipment in the equipment rack is accessible through at least a portion of the frame, and a closed position, in which access to the equipment through the portion of the frame is blocked by the door. A locking mechanism is mounted on at least one of said frame and said door for locking the door in the closed position.

### BRIEF DESCRIPTION OF THE DRAWINGS

FIG. 1 is a perspective of a door assembly according to the present invention mounted on a front frame of an equipment rack;

FIG. 2 is a perspective of the door assembly showing the doors in an alternative configuration;

FIG. 3 is a rear perspective of the door assembly; and

FIG. 4 is a right-side elevation of the door assembly.

Corresponding reference characters indicate corresponding parts throughout the drawings.

### DETAILED DESCRIPTION OF THE DRAWINGS

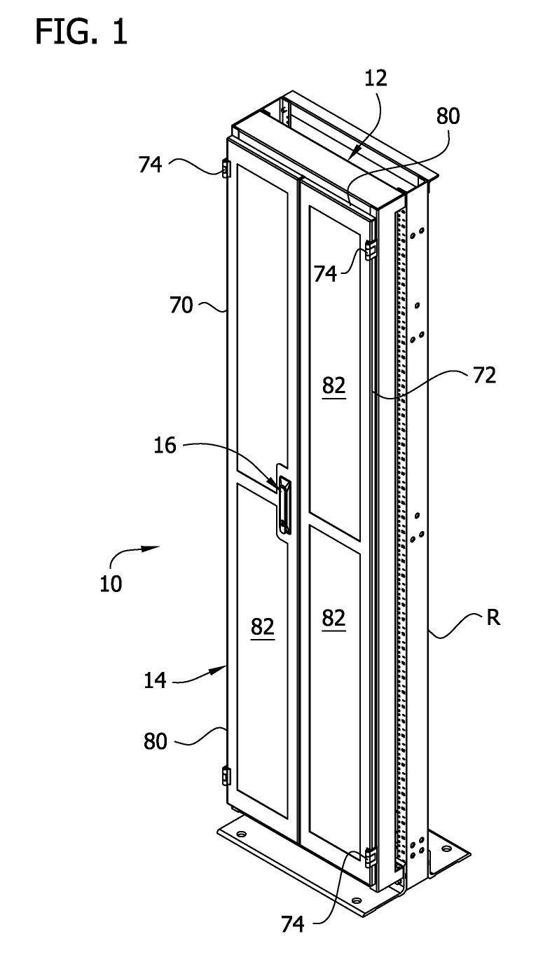

Referring to FIG. 1, a door assembly for an equipment rack is designated generally by the reference number 10. As will be understood by those skilled in the art, the door assembly 10 is used to secure the contents of an equipment rack R. Only a front frame of the equipment rack R is illustrated in the drawings. The door assembly 10 includes a unitary frame (generally designated by 12), doors (generally designated by 14), and a locking mechanism (generally designated by 16).

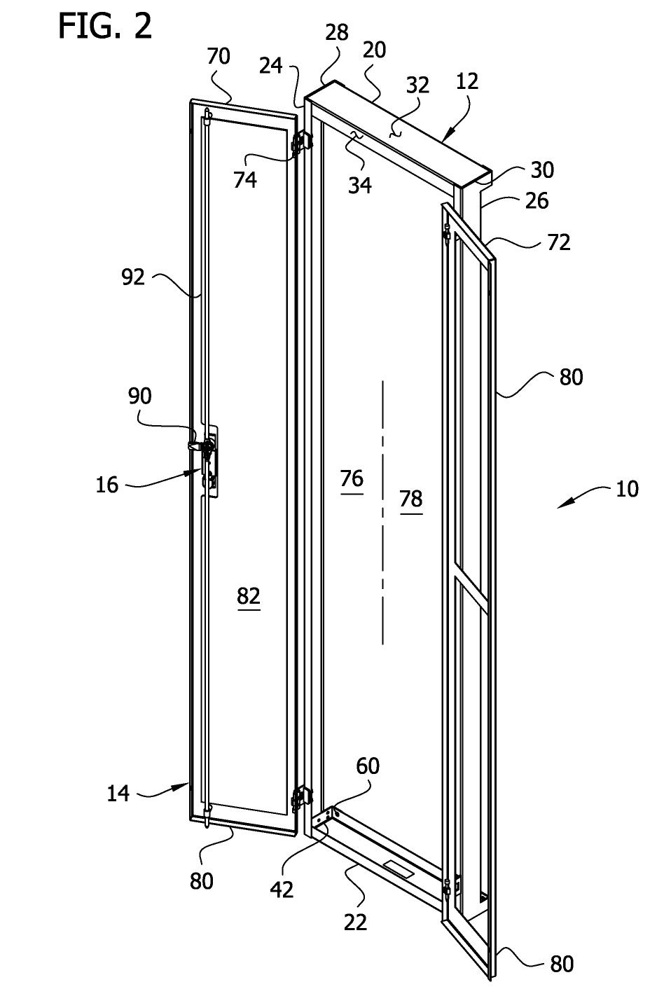

In the illustrated embodiment shown in FIG. 2, the unitary frame 12 includes an upper horizontal member 20, a lower horizontal member 22, a left-hand vertical member 24, and a right-hand vertical member 26. Although the frame 12 may be made from other materials without departing from the scope of the present invention, in one embodiment the frame are formed from steel channel. Although the channel may be made using other processes such as extrusion, in one embodiment the channel is made by bending steel sheet using roll forming equipment and/or a brake press. In the preferred embodiment, the upper and lower horizontal members 20, 22 and the left-hand and right-hand vertical members 24, 26 are joined to form the rectangular frame 12 having a size and shape corresponding to a size and shape of the equipment rack R on which the assembly 10 is intended to be mounted. Although other processes may be used to join the horizontal and vertical members without departing from the scope of the present invention, in one embodiment the members are joined by welding as will be explained in further detail below. As shown in FIG. 2, in some embodiments the unitary frame 12 has a height longer than its width, but other configurations are within the scope of the present invention.

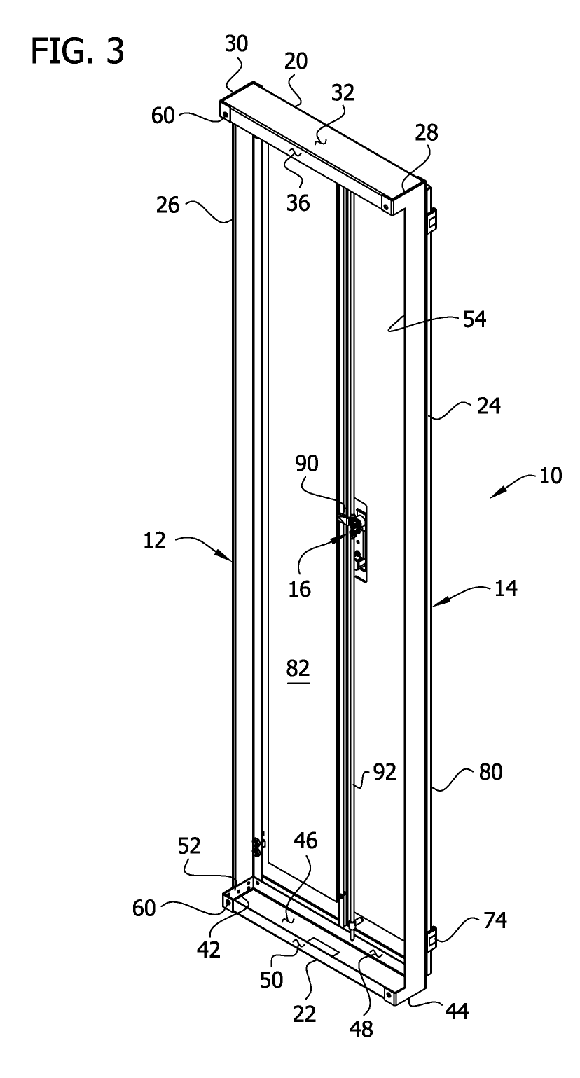

The upper horizontal member 20 extends from a left end 28 to a right end 30, defining a width that generally corresponds with a width of a conventional equipment rack R. In some embodiments, the width of the upper horizontal member 20 is in a range from about 19 inches to about 35 inches. The upper horizontal member 20 includes a top plate 32 defining a top surface of the unitary frame 12. As shown in FIG. 2, a forward flange 34 extends downward from a forward edge of the top plate 32, and as shown in FIG. 3, a rearward flange 36 extends downward from a rearward edge of the top plate, forming a rectangular channel. An end plate (not shown) extends downward from each end 28, 30 of the top plate 32, capping the ends of the upper horizontal member 20. The channel configuration of the upper horizontal member 20 improves security provided by the door assembly 10 by blocking access to fasteners joining the assembly to the rack R as will be described below.

The lower horizontal member 22 is configured similarly to the upper horizontal member 20. As shown in FIG. 3, the lower horizontal member 22 extends between a left end 42 and a right end 44, defining a width the same as the width of the upper horizontal member 20. Thus, the assembly 10 has a width that is the same as the widths of the upper horizontal member 20 and the lower horizontal member 22. The lower horizontal member 22 includes a bottom plate 46 defining a bottom surface of the unitary frame 12. As further illustrated in FIG. 3, the forward flange 48 extends upward from a forward edge of the bottom plate 46, and a rearward flange 50 extends upward from a rearward edge of the bottom plate, forming the lower horizontal member 22 as a generally rectangular channel. An end plate 52 similar to those of the upper horizontal member 20 extends upward from the left end 42 and the right end 44 between the forward flange 48 and the rearward flange 50, capping the ends of the lower horizontal member 22. The channel configuration of the lower horizontal member 22 improves security provided by the door assembly 10 by blocking access to fasteners joining the assembly to the rack R as will be described below.

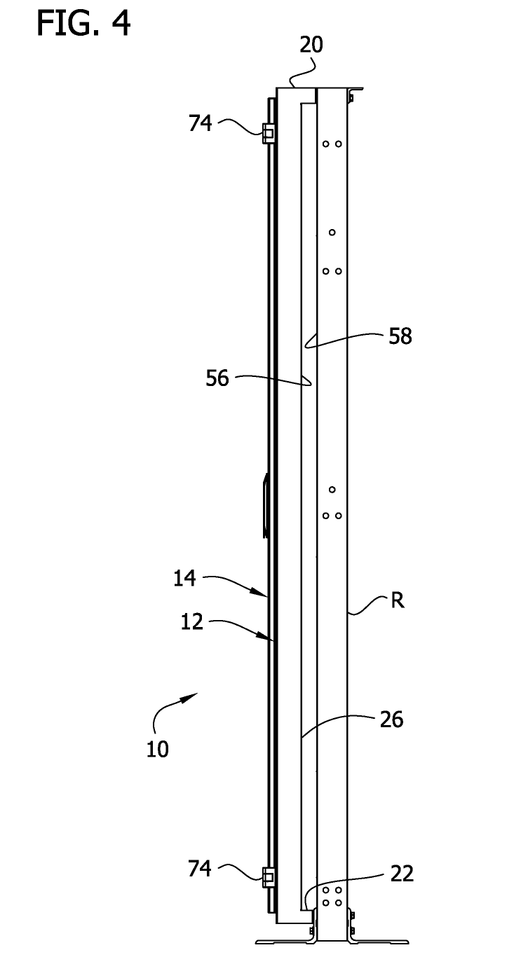

The left-hand vertical member 24 extends between the left end 28 of the upper horizontal member 20 and the left end 42 of the lower horizontal member 22, defining a height generally corresponding with a height of a conventional equipment rack R. In some embodiments, the height of the left-hand vertical member 23 is in a range from about 48 inches to about 96 inches. As illustrated in FIG. 3, the left-hand vertical member 24 has a rolled rearward edge 54 that is spaced from the rearward flanges 36, 50 of the upper and lower horizontal members 20, 22. This configuration provides an elongate slot (similar to slot 58 shown in FIG. 4) between the frame 12 and the equipment rack R on which it is mounted. In some embodiments, the slot extends uninterrupted from the upper horizontal member 20 to the lower horizontal member 22, permitting electrical connectors (e.g., temporary jumpers, not shown) to pass between the door assembly 10 and the equipment rack R. The slot also provides an opening for dissipating heat generated by the equipment in the racks R to prevent potentially damaging heat buildup around the equipment.

Similarly, the right-hand vertical member 26 extends between the right end 30 of the upper horizontal member 20 and the right end 44 of the lower horizontal member 22, defining a height the same as the height of the left-hand vertical horizontal member 24. Thus, the assembly 10 has a height that is the same as the heights of the left-hand vertical member 24 and the right-hand vertical member 26. As illustrated in FIG. 4, the right-hand vertical member 26 also has a rolled rearward edge 56 that is spaced from the rearward flanges 36, 50 of the upper and lower horizontal members 20, 22 to space the corresponding portion of the unitary frame 12 from the equipment rack R, thereby forming an elongate slot 58. Although the left-hand vertical member 24 and the right-hand vertical member 26 may be connected to the upper horizontal member 20 and the lower horizontal member 22 in other ways without departing from the scope of the present invention, in some embodiments the vertical members 24, 26 overlap the end plates (e.g., end plate 52) of the upper and lower horizontal members, and these overlapping elements are joined by spot welding as will be understood by those skilled in the art.

As shown in FIG. 3, the rearward flanges 36, 50 of the upper and lower horizontal members 20, 22, as well as rearward most flanges of the vertical members 24, 26 include openings 60 adapted to receive fasteners (not shown) to connect the unitary frame 12 to the equipment rack R. Although other types of fasteners may be used without departing from the scope of the present invention, in one embodiment the fasteners are screw fasteners such as bolts. As will be appreciated by those skilled in the art, the configurations of the upper and lower horizontal members 20, 22, as well as the left-hand and right-hand vertical members 24, 26 prevent easy access to the fasteners connecting the frame 12 to the rack R when the doors 14 are closed. Further, the general configuration permits the assembly 10 to be used to retrofit existing racks R. Still further, the configuration of the door assembly 10 of the present invention can easily be mounted to an equipment rack R without removing equipment housed in the rack.

As illustrated in FIG. 2, the doors 14 in some embodiments include a left-hand door 70 and a right-hand door 72. The left-hand door 70 is pivotally mounted on the left-hand vertical member 24, such as by a conventional hinge 74 so the left-hand door is movable between an open position (FIG. 2), in which equipment in the equipment rack R is accessible through a left-hand portion 76 of the unitary frame 12, and a closed position (FIG. 1), in which access through the left-hand portion of the unitary frame is blocked by the left-hand door. The left-hand portion 76 may extend an entire distance between the upper horizontal member 20 and the lower horizontal member 22 or some lesser distance. Similarly, the right-hand door 72 is pivotally mounted on the right-hand vertical member 26, such as by a conventional hinge 74. The right-hand door 62 is movable between an open position (FIG. 2), in which equipment in the equipment rack R is accessible through a right-hand portion 78 of the unitary frame 12, and a closed position (FIG. 1), in which access through the right-hand portion of the unitary frame 12 is blocked by the right-hand door. As with the left-hand portion 76, the right-hand portion 78 may extend the entire distance between the upper horizontal member 20 and the lower horizontal member 22 or some lesser distance.

As illustrated, door 14 includes a metal frame 80 fabricated from sheet steel holding visually transparent panes 82, allowing a user to see the equipment housed in the equipment rack R. In one embodiment, both the left-hand and right-hand doors 70, 72 include one or more visually transparent panes. Although the panes 82 may be made from other materials without departing from the scope of the present invention, in some embodiments the panes are made from polycarbonate or security glass. In this embodiment, the doors 60, 72 prevent access to the equipment held in the equipment rack R in the event malevolent persons gain access to the equipment room where the rack is located. Further, the transparent panes 82 permit visual inspection of the equipment in the racks R without opening the corresponding doors 70, 72.

As illustrated in FIGS. 1-3, the locking mechanism 16 is mounted on left-hand door 70. The locking mechanism 16 locks both the left-hand and right-hand doors 70, 72 in the closed position, thereby blocking access to the equipment in the rack R through the frame 12. In some embodiments, the locking mechanism 16 selectively locks the doors 70, 72 to each other and to the frame 12. As illustrated, in some embodiments the locking mechanism 16 includes a deadbolt portion 90 that, when in the locked position, engages right-hand door 72, thereby locking the doors to each other. The locking mechanism 16 also includes sliding bolts 92 that extend vertically and, when in the locked position, to engage the forward flanges 34, 48 of upper and lower horizontal members 20, 22, respectively, to lock the doors 70, 72 to the frame 12. As will be understood by those skilled in the art, the locking mechanism 16 may also include a keyed mechanism or a combination mechanism to selectively permit operation of the deadbolt portion 90 and the sliding bolts. Other locking mechanisms are envisioned as being within the scope of the present invention. For example, the locking mechanism may include a lock bolt and strike, or a locking mechanism mounted on the right-hand door or the unitary frame.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A door assembly for an equipment rack, the assembly comprising:
a unitary frame including:
an upper horizontal member extending between a left end and right end opposite the left end;
a left-hand vertical member extending downward from an upper end connected to the left end of the upper horizontal member to a lower end opposite the upper end; and
a right-hand vertical member extending downward from an upper end connected to the right end of the upper horizontal member to a lower end opposite the upper end;
a left-hand door pivotally mounted on the left-hand vertical member for movement between an open position, in which equipment in the equipment rack is accessible through a left-hand portion of the frame, and a closed position, in which access to the equipment through the left-hand portion of the frame is blocked by the left-hand door;
a right-hand door pivotally mounted on the right-hand vertical member for movement between an open position, in which equipment in the equipment rack is accessible through a right-hand portion of the frame, and a closed position, in which access to the equipment through the right-hand portion of the frame is blocked by the right-hand door; and
a locking mechanism mounted on at least one of said frame, said left-hand door, and said right-hand door for locking the left-hand door and right-hand door in their respective closed positions, thereby blocking access to the equipment through the frame.

2. A door assembly as set forth in claim 1 wherein the upper horizontal member includes an opening for receiving a fastener to fasten the frame to the equipment rack.

3. A door assembly as set forth in claim 2 wherein:
the upper horizontal member comprises a top plate, a forward flange extending downward from a forward edge of the top plate, and a rearward flange extending downward from a rearward edge of the top plate; and
the opening in the upper horizontal member comprises a hole through the rearward flange so the fastener is inaccessible when the door assembly is installed on the equipment rack and the doors are locked in their respective closed positions.

4. A door assembly as set forth in claim 1 wherein the unitary frame further includes a lower horizontal member spanning between the lower end of the left-hand vertical member and the lower end of the right-hand vertical member.

5. A door assembly as set forth in claim 4 wherein:
the upper horizontal member includes an opening for receiving a fastener to fasten the frame to the equipment rack; and
the lower horizontal member includes an opening for receiving a fastener to fasten the lower horizontal member to the equipment rack.

6. A door assembly as set forth in claim 2 wherein:
the lower horizontal member comprises a bottom plate, a forward flange extending upward from the bottom plate, and a rearward flange extending upward from a rearward edge of the bottom plate; and
the opening in the lower horizontal member comprises a hole through the rearward flange so the fastener is inaccessible when the door assembly is installed on the equipment rack and the doors are locked in their respective closed positions.

7. A door assembly as set forth in claim 1 wherein the frame is configured so a left-hand opening is formed between the left-hand vertical member and the equipment rack and a right-hand opening is formed between the right-hand vertical member and the equipment rack when the door assembly is installed on the equipment rack.

8. A door assembly as set forth in claim 7 wherein the left-hand opening and the right opening are both slots having a height longer than a width.

9. A door assembly as set forth in claim 8 wherein:
the left-hand opening extends substantially an entire height of the left-hand member of the frame; and
the right-hand opening extends substantially an entire height of the right-hand member of the frame.

10. A door assembly as set forth in claim 1 wherein:
at least a portion of the left-hand door is visually transparent; and
at least a portion of the right-hand door is visually transparent.

11. A door assembly as set forth in claim 10 wherein:
the left-hand door comprises a visually transparent panel; and
the right-hand door comprises a visually transparent panel.

12. A door assembly as set forth in claim 1 wherein the locking mechanism comprises a deadbolt and a vertical sliding bolt mounted on one of said left-hand door and said right-hand door.

13. A door assembly for an equipment rack, the assembly comprising:
an upper horizontal member extending between a left end and a right end, the upper horizontal member having an opening for receiving a fastener to fasten the frame to the equipment rack;
a lower horizontal member extending between a left end and a right end, the lower horizontal member having an opening for receiving a fastener to fasten the frame to the equipment rack;
a left-hand vertical member joining the left end of the upper horizontal member to left end of the lower horizontal member, at least a portion of a rearward surface of the left-hand vertical member being offset from those of the upper horizontal member and the lower horizontal member so the left-hand vertical member is spaced from the equipment rack when the door assembly is fastened to the equipment rack and so the left-hand vertical member partially defines an opening between the left-hand vertical member and the equipment rack;
a right-hand vertical member joining the right end of the upper horizontal member to right end of the lower horizontal member, at least a portion of a rearward surface of the right-hand vertical member being offset from those of the upper horizontal member and the lower horizontal member so the right-hand vertical member is spaced from the equipment rack when the door assembly is fastened to the equipment rack and so the right-hand vertical member partially defines an opening between the right-hand vertical member and the equipment rack;
a door pivotally mounted on one of the left-hand vertical member and the right-hand vertical member for movement between an open position, in which equipment in the equipment rack is accessible through at least a portion of the frame, and a closed position, in which access to the equipment through the portion of the frame is blocked by the door; and
a locking mechanism mounted on at least one of said frame and said door for locking the door in the closed position.

14. An assembly as set forth in claim 13 wherein the door is a left-hand door pivotally mounted on the left-hand vertical member, and the assembly further comprises a right-hand door pivotally mounted on the right-hand vertical member.

15. A door assembly as set forth in claim 13 wherein:
the upper horizontal member comprises a top plate, a forward flange extending downward from a forward edge of the top plate, and a rearward flange extending downward from a rearward edge of the top plate;
the opening in the upper horizontal member comprises a hole through the rearward flange of the upper horizontal member so the fastener is inaccessible when the door assembly is installed on the equipment rack and the door is locked in its closed position;
the lower horizontal member comprises a bottom plate, a forward flange extending upward from the bottom plate, and a rearward flange extending upward from a rearward edge of the bottom plate; and
the opening in the lower horizontal member comprises a hole through the rearward flange so the fastener is inaccessible when the door assembly is installed on the equipment rack and the door is locked in its closed position.

16. A door assembly as set forth in claim 13 wherein at least a portion of the door is visually transparent.

17. A door assembly as set forth in claim 16 wherein the door comprises a visually transparent panel.
